(19) United States
(12) Patent Application Publication
(10) Pub. No.: US 2012/0207900 A1
(43) Pub. Date: Aug. 16, 2012

(54) Method of making pasta filata cheese without cooling in brine or other liquid

(75) Inventor: Denis M. Singleton, St. Laurent (CA)

(73) Assignee: Saputo Cheese G.P.

(21) Appl. No.: 13/506,225

(22) Filed: Apr. 5, 2012

Related U.S. Application Data
(63) Continuation of application No. 12/045,349, filed on Mar. 10, 2008, now abandoned.

(51) Int. Cl. A23C 19/06; A23C 19/068; A23C 19/064; A23C 19/024

(52) U.S. Cl. 426/509

(57) ABSTRACT

A method of making pasta filata cheese (and the resulting cheese) uses a conventional pasta filata cheese making process except that the cheese mass, after cooking and stretching, is not cooled in brine or other liquid. Instead, the cheese is cooled through other means, such as by being rolled into the form of a sheet on a conveyor, and then cooled on the conveyor. The cheese may be (but need not be) frozen on the conveyor or thereafter, and comminuted.

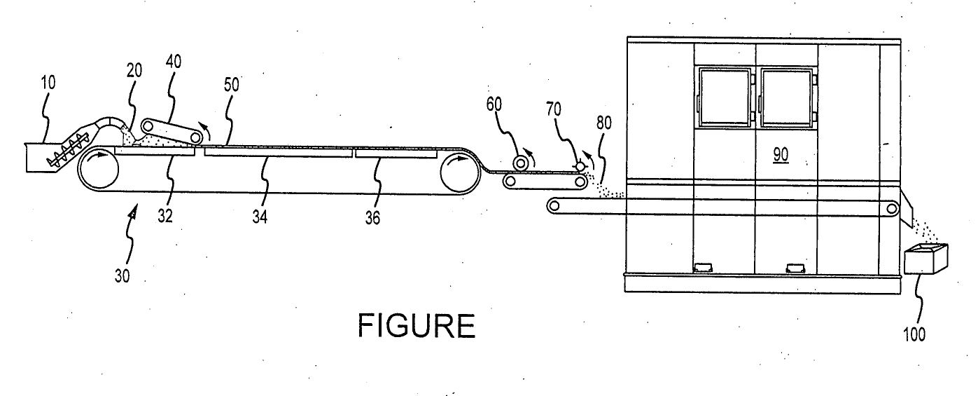

This application is a continuation of co-pending U. S. non-provisional patent application Ser. No. 12/045,349, filed on Mar. 10, 2008.

### FIELD OF THE INVENTION

The present invention relates to a continuous process of manufacturing, comminuting, and packaging pasta filata cheese, and more particularly to a process in which the cheese produced is immediately functional when thawed from a frozen state or which has an extended shelf life if distributed and used in a substantially unfrozen state.

### BACKGROUND

The dairy industry has for many years attempted to reduce costs by increasing the moisture and fat content of mozzarella varieties, by reducing the ageing requirements of the cheese so that it is ready for immediate use, or by extending the functional life of the cheese. However, the criteria to achieve each of these attributes may be contradictory. For example, increasing the cheese moisture typically reduces the shelf life as the cheese becomes too soft and loses its functionality too rapidly after manufacture. One approach to prevent the loss of functionality has been to immerse the curd or cheese mass in cold brine followed by freezing the cheese very rapidly after manufacture.

Barz, in 1990, taught a process where ageing could be dispensed with in a mozzarella cheese if the process is controlled to yield a combined moisture and wet milkfat content of at least 70% and where the cheese is used or frozen within 48 hours after brining. US Pat. No. 5,200,216.

Barz, in 1992, taught an improvement to U.S. Pat. No. 5,200,216 wherein the heated cheese is cooled by being extruded as a continuous ribbon into cold sodium chloride brine and the cheese ribbon is held in cold sodium chloride until its temperature drops to about 75 F or below, after which the cooled ribbon is cut into sections which are subsequently comminuted and quick frozen. U.S. Pat. No. 5,234,700.

Another approach has been to cool the cheese very rapidly by immersing ready to serve cheese pieces in a salt-free water environment followed by rapidly freezing the cheese. DeLucia, in 2001, disclosed a method for shock and deep frozen pieces of mozzarella, which are ready to be served or for scattering on pizzas for baking. An important feature of the invention is that the fresh mozzarella, which is obtained from curd, is treated immediately exclusively by quenching in salt-free water, preferably in a water bath having a temperature of 5 C-10 C. DE 101,41,914 C5.

All of these discoveries rely on immersion of the curd or the cheese in a liquid to facilitate cooling prior to quick freezing. The processed cheese industry has taken an alternative approach whereby a hot molten processed cheese mass is spread thinly over a chill belt. The chill belt rapidly cools the hot-process cheese mass. This approach has been very successful in the production of process cheese such as process American cheese. U.S. Pat. No. 2,352,210 discloses an apparatus for continuously producing a sheet of a cheese product and for cutting or slitting such a sheet to form it into longitudinal ribbons.

Miller describes an automated system for making pre-sliced individually wrapped cheese slices which includes the step of cooling a continuous sheet of molten cheese by passing it over a chill roll. As the sheet of cheese leaves the chill roll, it is slit to form continuous ribbons. U.S. Pat. No. 3,479,024.

Miller improved on this process for the handling of a weak bodied cheese such as occurs with process cheese spreads, and in 1973 described an apparatus and method for handling a process cheese spread product, for division into slices that included distributing the cheese spread in a flowable state onto a chill roll so that it is formed into a sheet, separating the sheet from the chill roll, and transporting the sheet upon a conveyor away from the chill roll. The sheet is supported across its width and along its length while it moves toward apparatus for slitting the sheet into a plurality of adjacent longitudinal strips and for cutting the strips transversely into slices of desired length and width. U.S. Pat. No. 3,887,719.

The known approaches using a chill roll have been applied to process cheese types. A conventional distinction is made between processed cheese and natural cheese (which includes pasta filata varieties) because of the substantially different methods of making the two products.

Natural cheese is made from milk solids (curds) that have been separated from milk (liquid portion, whey) by a coagulating enzyme such as rennet and/or by acidification such as from a bacterial culture. Natural cheese is essentially a dehydration process in which the fat and casein in milk are concentrated by acidification, coagulation, dehydration, cutting the coagulum, cooking, stirring, pressing, salting and other operations that promote gel syneresis, shaping and salting. The degree of dehydration is regulated by the extent and combination of these operations. For example, pasta filata is conventionally made by the following steps: 1) Standardizing (typically) cow milk to a desired fat and protein level, 2) Pasteurizing, 3) Acidifying with bacterial culture or acid, 4) Adding coagulating enzymes to form a coagulum or gel, 5) Cutting the coagulum or gel, 6) Cooking to temperatures around, for example, 113 F to reduce moisture in the coagulum, 7) Draining of the whey, 8) Cooking and stretching of the curd, 9) Molding the curd following by immersion in cold brine. The foregoing process is referred to as a conventional process herein.

A processed cheese is a mixture of fresh and aged natural cheese that has been pasteurized and may have added flavors. It may be made by melting various types of cheese together and adding butter, milk, or cream. Thus a uniform gel-like structure is obtained suitable . for slicing and melting. Process cheese types include process cheese, process cheese food and process cheese spread. In process cheese, the moisture and fat are at levels close to the legal limit of the natural cheese used. (Legal limit is a reference to the United States Code of Federal Regulations, Chapter 21, the contents of which are incorporated by reference). Process cheese food contains not more than 44% moisture and not less than 23% milk fat and may have added non fat dry milk, whey solids and water, and process cheese spread has higher moisture and lower milk fat content (contains not less than 44% and not more than 60% moisture and not less than 20% milk fat).

Meyer, in 1985 partly merged the processed cheese concept of rolling the molten cheese mass into a ribbon. The invention related to an apparatus and to a technique for producing sliced, shredded and/or diced mozzarella and provolone. The technique includes the steps of placing the cheese in a heated, deformable state, forming an extended ribbon of cheese, applying pressure to the ribbon of cheese to reduce its thickness and cutting the flattened ribbon after brining and cooling. U.S. Pat. Nos. 4,665,811 and 4,626,439. Meyer, however, did not cool the cheese mass as it was being formed into a ribbon. In fact the flattened cheese ribbon was instead partly cooled by passing it through brine and further cooled after brining by passing the ribbon over a glycol filled cooling table.

### BRIEF DESCRIPTION OF THE DRAWING

The FIGURE is a schematic representation of apparatus useful for making cheese according to the teachings herein.

### DESCRIPTION OF THE INVENTION

It has now been discovered that varieties of natural cheese produced by a process including a step resulting in the formation of a hot homogenous mass can be cooled in the absence of a liquid medium, and subsequent to the cooling process the curd mass can be sliced, diced, or shredded (“comminuted” herein, which generally describes dividing the cheese into smaller pieces by any means) for immediate packaging. In the process of the present invention, the conventional steps of producing a natural cheese are employed, except that the hot cheese mass is cooled immediately without immersion in any cooling liquid medium, and the cooled mass is then comminuted and packaged in what may be a continuous cheesemaking process. In a preferred embodiment of the invention, the cheese mass is rolled into a flat sheet at the beginning of a conveyor such as a belt conveyor and the sheet is progressively cooled without immersion in liquid as it moves towards the end of the conveyor. For example, the cheese at the start of the conveyor may be typically about 130 F-160 F; as it moves from the start of the conveyor to the end it is cooled gradually to the target end temperature of 20 F-32 F. The cooled sheet of cheese can then be comminuted and packaged in a continuous process. In an embodiment of the invention the temperature of the cheese sheet at the end of the conveyor is less than 32 F and the slicing, dicing and shredding may be performed at less than 32 F and subsequently packaged. The packaged cheese may be distributed through a frozen or chilled distribution system.

This process has a number of benefits. The process allows for the production of natural cheese at high moisture and fat content which can then be cooled and comminuted immediately without incurring the detrimental effect of excessively soft body that typically occurs if high moisture natural cheese is stored prior to comminuting. The process allows for the immediate freezing of the comminuted curd which eliminates the normal need to hold cheese prior to comminuting. The process allows for the freezing of the cheese mass prior to comminuting or immediately after comminuting with subsequent maintenance of the cheese under frozen conditions for the remaining steps of the packaging and distribution process. This process eliminates the requirement to ripen cheese before use and the cheese is functional from the frozen state or after thawing. The rapid and immediate cooling and freezing of the curd or cheese mass allows for the cheese to be produced at a higher than normal moisture and fat content without the need for ripening the cheese. The resulting cheese has good functionality and if maintained in the frozen state is expected to have shelf life of at least 1 year.

The process allows for the freezing of the cheese mass before or immediately after comminuting with subsequent maintenance of above freezing conditions for the remainder of the packaging and distribution process. The rapid and immediate cooling or freezing of the curd or cheese mass allows for the cheese to be produced at a higher than normal moisture and fat content and, if the resulting cheese is maintained at distribution temperatures above freezing, it should retain a shelf life at least as long as a comparable lower moisture product because the rapid cooling reduces the rates of enzymatic and chemical breakdown associated with higher moisture.

The rapid and immediate cooling or freezing of the curd or cheese mass allows for the cheese to be produced at a normal moisture and fat content and if the resulting cheese is maintained at distribution temperatures above freezing it will retain a shelf life that is longer than a comparable moisture product because the rapid cooling reduces the rates of enzymatic and chemical breakdown associated with ripening.

The elimination of brine or salt-free water (or more generally any other liquid) as a cooling medium has additional advantages. A liquid cooling process requires significant space for the handling and cooling of the liquid medium. The brining equipment is generally very expensive due to the corrosive nature of high saline solutions. The environmental impacts of brine are considerable with the impact of electrical conductivity and salt being major regulatory issues due to their impact on aquifers and water quality. The efficiency of cooling a hot cheese mass is related to the surface to volume ratio of the product versus the cooling medium. Brine and water systems typically require considerable volume due to the inefficient cooling process further compounding both equipment and environmental concerns. Salt diffusion into cheese in brine is accompanied by moisture loss from the cheese to the brine. Additionally, other components from the cheese such as fat and minerals also migrate to the brine. This is an economic loss and there is a subsequent cost to trying to recover these components. The loss of fat and other cheese components also occurs in water with the same detrimental impacts. If the outside of the cheese is not cooled adequately to form a skin, the loss of cheese components is even more dramatic.

Cooling cheese according to the present invention gives many other advantages over the use of brine and water cooling systems. The temperature of the cheese can be finely controlled coming off the end of the conveyor. There is a significant reduction in cheese fines if the cheese is comminuted at lower temperatures. In fact, the moisture in the cheese can be increased substantially if the cheese is comminuted or sliced at lower temperature. A very acceptable cheese dice can be produced with little or no fines if the comminution process takes place at a few degrees above or a few degrees below the freezing point of water, for example, at between 20 F-36 F, or 20 F-28 F. Alternatively, the comminution process may take place at other temperatures, for example, without limitation, at temperatures at or below about 45 F.

It has additionally been found that other ingredients can easily be added to the cheese and that the conveyor substantially improves the ability to handle the resulting hot cheese mass. Examples but not limitations of ingredients that can be added to the cheese are starches, flavors, salts, colors, dairy ingredients, non-dairy ingredients, texture modifiers such as emulsifiers or stabilizers or acids. The conveyor allows easy handling of the blended mass and the rapid cooling means that variation in the body and texture of the cheese mass can easily be accommodated and the temperature off the end of the conveyor can be manipulated to ensure that the body of the cheese is acceptable for comminution.

Additionally, other ingredients can be easily added to the milk for cheesemaking that would normally make the cheese difficult to handle. Examples but not limitations of ingredients that can be added to the cheese milk are whey protein concentrates, whey, milk proteins, cream, and nfdm. An example of this would be the inclusion of substantial quantities of denatured whey proteins, in the cheese milk. This would normally result in a high-moisture difficult-to-handle cheese mass due to the softness that is incurred as a result of the weaker bodied whey protein and the high moisture in the cheese. The conveyor can easily handle the softer body; and the temperature off the end of the conveyor can be controlled to ensure that the body of the cheese is acceptable for comminution. Other examples are the use of acids added either directly or produced in situ in the milk by bacteria wherein the level of the acid can be used to modify the texture of the finished cheese such that it is immediately functional. The functionality is stabilized by immediately passing the hot cheese mass over the conveyor wherein it is frozen prior to comminution or chilled, followed by comminution and subsequent freezing or chilled or frozen prior to above freezing distribution.

Additionally, the very large surface to volume ratio of the cheese sheet on the chill belt allows for the efficient application of a fine spray over the surface of the cheese sheets. For example, the sheet can be about 36″ wide by 0.25″ high. The length of the conveyor can be about 20 feet. None of these dimensions are critical. The spray may be only water or it may contain added ingredients such as but not limited to texture modifiers or flavor modifiers. The spray will quickly be absorbed on the large surface area if the sheet is only chilled or it will be quickly frozen if the cheese sheet is frozen. The spray may be used to modify texture, or include a dissolved emulsifying salt to improve functionality when the cheese is on a pizza, to increase moisture, or for other reasons.

### EXAMPLE 1

Pasta Filata cheese is made by conventional means to the point that the hot molten cheese mass is removed from the cooker stretcher. The cooker stretcher may be a traditional wet cooker process in which the curd is worked under water or it may be a dry cooker process. The cheese mass, having a temperature of typically 130 F-160 F, is then extruded onto a conveyor. The extruded cheese mass is pressed using one or more rollers on a conveyor to form a thin cheese sheet. (“Thin” means that the cheese mass has a width significantly greater than its height, so that it is in the form of a sheet.) The process includes cooling the cheese mass on the conveyor. This can be accomplished with a number of apparatus, and the precise manner of cooling is not critical. For example, the conveyor belt can be chilled such as with a refrigerant such as glycol or CO2, or the environment can be cooled with example N or CO2. The temperature of the cheese mass is reduced as it moves towards the end of the conveyor. (More than one conveyor can be used as a matter of design choice.) The temperature of the cheese sheet at the end of the conveyor is reduced to below freezing, such as about 25 F, after which the chilled cheese sheet is then peeled from the end of the conveyor. The peeling can occur automatically at the end of the conveyor or through any technique to peel a sheet from a conveyor, as is well known. The sheet is then fed to a dicer.

The diced pieces are then packaged and maintained under frozen conditions through distribution. This cheese is functional from being frozen or subsequent thawing and is expected to have a shelf life of at least a year in the frozen state.

### EXAMPLE 2

Pasta Filata cheese is produced essentially the same as in Example 1, wherein the cheese making process was modified using conventional cheese making techniques to result in a high moisture and fat in the resulting cheese. Cheese with a moisture content of between about 48% and 65% is produced with a fat content of about 45% (between about 35% and 55%) on a dry basis. The rapid and controlled cooling and freezing of the cheese mass on the conveyor followed by immediate dicing results in a high moisture/fat cheese that can be easily diced and will have immediate functionality upon thawing.

### EXAMPLE 3

Pasta Filata is produced essentially the same as in Example 1, wherein the cheese sheet is cut into shreds which were maintained at temperatures above freezing (such as between about 32 F-45 F) during distribution. This cheese has an extended shelf life as the rapid rate of cooling retards the normal chemical and enzymatic changes associated with slower cooling rates. Distribution herein means delivering the cheese to an end user, e.g., a user who applies the cheese to pizza.

### EXAMPLE 4

Pasta Filata is produced essentially the same as in Example 2, wherein the shredded cheese was maintained at temperatures above freezing throughout distribution. This cheese should have a comparable shelf life to a lower moisture cheese that has not been rapidly cooled to below or close to freezing prior to packaging.

### EXAMPLE 5

Pasta filata cheese is prepared as for Example 2 but the temperature of the cheese sheet off the end of the conveyor is above freezing, such as between 32 F-40 F. The diced pieces are then subsequently frozen in a freezer, preferably an instant quick freeze type freezer whereby the granules will be maintained in free flowing conditions. It should be apparent, more generally, that the cheese may be frozen on the conveyor, or in a separate freezing operation, or not frozen at all.

### EXAMPLE 6

Pasta Filata is produced essentially as per Example 2, wherein denatured wpc is added to the cheese milk to facilitate increased cheese moisture.

### EXAMPLE 7

Pasta Filata is produced essentially as per Example 2, wherein lactic or citric acid or a blend is added to a pH of about 5.75. The curd produced is conveyed directly to the cooker stretcher or is allowed to develop more acidity by bacterial acidification. The curd is subsequently worked and processed as per Example 2. The addition of acid can be used to modify the cheese functionality.

### EXAMPLE 8

Pasta Filata is produced essentially as per Examples 1, 2, 6 or 7 and the curd is mixed with nfdm with or without minor amounts (such as less than 1%) of emulsifying ingredients and subsequently worked in a cooker stretcher. The hot worked curd is then chilled to about 25 F on the conveyor and the chilled cheese sheet is cut into slices which can be maintained in frozen or unfrozen form.

### EXAMPLE 9

Pasta Filata is prepared as per Examples 1, 2, 6, 7 or 8 and a spray, such as a spray containing water or water with sodium citrate is sprayed onto the surface of the cheese sheet.

A process for making cheese illustrating the teachings herein and additional aspects are described in connection with the FIGURE. A conventional cheese cooker 10 such as for cooking pasta filata cheese deposits a cheese (curd) mass 20 onto a conveyor 30 such as a belt conveyor. The mass is deposited onto a heating zone 32 proximate the beginning of the conveyor to facilitate spreading of the mass into a sheet (if the belt is too cold at the start, movement/spreading of the mass will be locally restricted at the cold contact points and the spread is less uniform). One or more rollers or other flattening devices 40 flatten the mass into a ribbon 50 (which is referred to as a cheese sheet elsewhere herein). The ribbon 50 moves onto a freezing (or chill) zone of the conveyer 34 that freezes or chills the ribbon 50, depending on the embodiment. The ribbon then moves onto the heating zone 36 proximate the end of the conveyor 30. The purpose of the heating zone 36 at the end is to facilitate removing the cold ribbon 50 of cheese (heat reduces the adhesive strength between the ribbon 50 and the conveyor 30 to facilitate separation). The ribbon 50 is processed by one or more comminuting devices such as a slitter 60 and dicer 70 to form comminuted cheese 80. The comminuted cheese 80 may be frozen in a blast air freezing tunnel 90 and deposited into packaging 100.

It should be understood that the above examples are non-limiting.

It should be clear that the present invention includes any cheese made by the aforementioned processes. Moreover, while the invention has been described with reference to specific embodiments, modifications and variations of the invention may be made without departing from the scope of the invention, which is defined in the following claims and the equivalents thereto. All references are incorporated herein by reference.

1. A method of making pasta filata cheese comprising the steps of:
(a) cooking and stretching a pasta filata cheese curd to form a cheese mass;
(b) extruding the cheese mass onto a conveyor;
(c) rolling the cheese mass to form a cheese sheet;
(d) cooling the cheese sheet, without immersing it in a liquid coolant, to a temperature at or below about 45 F; and
(e) immediately comminuting the cooled cheese sheet of step (d), and wherein steps (c) and (d) are performed on the conveyor.

2. The method of claim 1, wherein the step of cooling is accomplished by using a chilled conveyor.

3. The method of claim 1, wherein the step of cooling the cheese sheet is accomplished by cooling an environment in which the conveyor is located.

4. The method of claim 1, wherein the cheese sheet is cooled to the freezing point of water or below.

5. The method of claim 1, further comprising the steps of controlling the moisture content of the cheese curd so that the cheese sheet has a moisture content of between about 48% and 65% and controlling the fat content of the cheese curd so that the cheese sheet has a fat content of between about 35% and 55% on a dry basis.

6. The method of claim 1, further comprising the step of distributing the comminuted cheese to a user wherein the comminuted cheese has been maintained at a temperature above the freezing point of water.

7. The method of claim 1, wherein the cheese sheet is not cooled to below freezing, and further comprising the step of freezing the comminuted cheese.

8. The method of claim 1, wherein the pasta filata cheese curd is mixed with denatured wpc and wherein the cheese sheet is cooled to a sufficient temperature to provide acceptable comminution.

9. The method of claim 1, wherein the pasta filata cheese curd is mixed with acid to a pH of about 5.75.

10. The method of claim 1, wherein the cheese sheet is sprayed with a liquid.

11. The method of claim 11, wherein the liquid with which the cheese sheet is sprayed contains water and sodium citrate.

12. The method of claim 1, wherein the conveyor has a heating zone proximate a beginning of the conveyor to facilitate formation of the cheese sheet.

13. The method of claim 1, further comprising the step of removing the cheese sheet from the conveyor, wherein the removing step is facilitated by a heating zone proximate an end of the conveyor.
